(19) United States
(12) Patent Application Publication
(10) Pub. No.: US 2026/0103206 A1
(43) Pub. Date: Apr. 16, 2026

(54) SCALABLE VEHICULAR CONTROL SYSTEM WITH ERROR MANAGEMENT

(71) Applicant: Magna Electronics Inc., Auburn Hills, MI (US)

(72) Inventors: Bishnu Raveendran, Rochester, MI (US); Shalhoob Vadakayvetil Manatheykad, Redford, MI (US); Pramod Kumar, Farmington Hills, MI (US)

(21) Appl. No.: 19/357,358

(22) Filed: Oct. 14, 2025

Related U.S. Application Data
(60) Provisional application No. 63/708,030, filed on Oct. 16, 2024.

(51) Int. Cl. B60W 50/029; B60R 16/023; B60W 50/035

(52) U.S. Cl. CPC B60W 50/029; B60R 16/0232; B60W 50/035

(57) ABSTRACT

A vehicular control system includes a plurality of sensors disposed at a vehicle and operable to capture sensor data. An electronic control unit (ECU) is disposed at the equipped vehicle. Sensor data captured by the plurality of sensors is transferred to the ECU. The ECU includes primary core circuitry and a plurality of secondary core circuitry. Each secondary core circuitry of the plurality of secondary core circuitry is operable to process sensor data captured by at least one sensor of the plurality of sensors and transferred to the ECU. At least one secondary core circuitry of the plurality of secondary core circuitry, responsive to processing captured sensor data, communicates an error status to an inter-process communication (IPC) layer. The primary core circuitry, responsive to receiving the error status from the at least one secondary core circuitry via the IPC layer, degrades a driving assistance system that uses the sensor data.

### CROSS REFERENCE TO RELATED APPLICATION

The present application claims the filing benefits of U.S. provisional application Ser. No. 63/708,030, filed Oct. 16, 2024, which is hereby incorporated herein by reference in its entirety.

### FIELD OF THE INVENTION

The present invention relates generally to a vehicular control system for a vehicle and, more particularly, to a vehicular control system that performs error management.

### BACKGROUND OF THE INVENTION

Use of imaging sensors in vehicle imaging systems is common and known.

Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular control system includes a plurality of sensors disposed at a vehicle equipped with the vehicular control system, where individual sensors of the plurality of sensors sense exterior of the equipped vehicle and are operable to capture sensor data.

An electronic control unit (ECU) disposed at the vehicle includes electronic circuitry and associated software. Sensor data captured by the plurality of sensors is transferred to the ECU. The electronic circuitry of the ECU includes primary core circuitry and a plurality of secondary core circuitry. Each secondary core circuitry of the plurality of secondary core circuitry is operable to process sensor data captured by at least one sensor of the plurality of sensors and transferred to the ECU. At least one secondary core circuitry of the plurality of secondary core circuitry, responsive to processing the sensor data captured by the at least one sensor of the plurality of sensors and transferred to the ECU, communicates an error status to an inter-process communication (IPC) layer. The primary core circuitry, responsive to receiving the error status from the at least one secondary core circuitry via the IPC layer, degrades a driving assistance system that uses the sensor data captured by the at least one sensor of the plurality of sensors and transferred to the ECU.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a safety architecture that implements scalable error management;

FIG. 2 is a block diagram of an error manager satellite communicating a packet of data to an error manager aggregator;

FIG. 3 is a block diagram of a vehicular control system that includes multiple error satellites that communicate errors to a primary ECU;

FIG. 4 is a table of data that illustrates the runtime performance of an example safety architecture that uses scalable error management;

FIG. 5A is a block diagram of a safety architecture that includes scalable error management;

FIG. 5B is a block diagram of a safety architecture that includes scalable error management;

FIGS. 5C-1 and 5C-2 together are a block diagram of a safety architecture that includes scalable error management;

FIG. 6 is a block diagram of a safety architecture that includes a single SOC with multiple cores;

FIG. 7 is a block diagram of a safety architecture that includes multiple SOCs; and

FIG. 8 is a block diagram of a safety architecture that is implemented at a vehicle level.

### DESCRIPTION OF THE PREFERRED EMBODIMENTS

Vehicular error management generally includes cores that monitor errors from systems (i.e., systems, drivers, components, software components (SWCs), features, or applications) of the vehicle. Error management may further include the cores processing error reports from the systems. Based on an error reported by a system, a core may degrade performance of the system, set a diagnostic trouble code (DTC) for communication to other cores and/or ECUs of the vehicle and/or a driver of the vehicle, or set, communicate, or assert a safe state to other cores or ECUs of the vehicle. Generally, each core performs error management locally. In other words, each core performs error management in parallel with or isolation from the error management of the other cores.

A vehicle control system and/or driver or driving assist system and/or object detection system and/or alert system may be operable to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

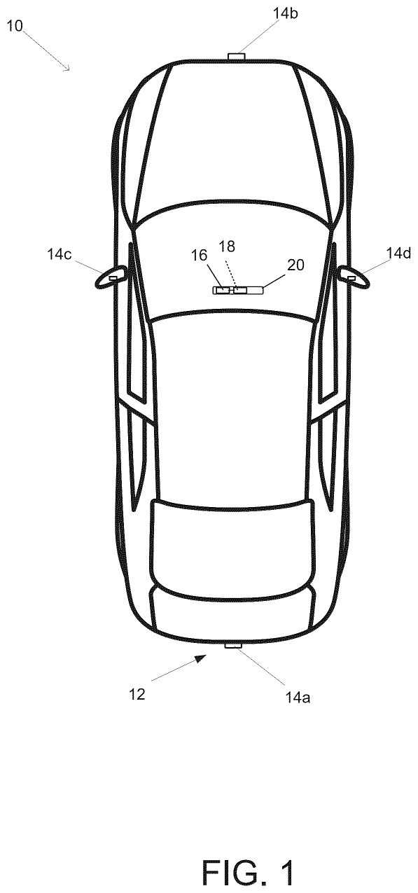

Referring now to the drawings and the illustrative embodiments depicted therein, a vehicle 10 includes an imaging system or control system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). The imaging system may include any number of other sensors, such as radar sensors, lidar, ultrasonics, etc. Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The image system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

The imaging system or control system may include or be part of an advanced driver assistance system (ADAS) or other system that supports the driver or functions of the vehicle 10. To prevent or mitigate the potential failure of one or more of these features during vehicle operation, the vehicular control system includes a safety architecture. The safety architecture of the vehicular control system can vary in size and scope. In one example, the safety architecture may include a single System-on-a-Chip (SOC) having multiple cores. In another example, the safety architecture may include multiple SOCs. In a further example, the safety architecture may be implemented at a vehicle level, including multiple systems, such as a front camera system, a radar system, and an ultrasonic system. Each system may be implemented on an ECU dedicated to that system.

Implementations herein include a vehicular control system with scalable error management that includes defining all errors, function degradations, dependencies of function degradations, and safe states related to the safety architecture in one location. Safety architecture software that uses scalable error management is portable and may be deployed in any software environment (e.g., C-based software environment). In a vehicular control system involving the integration of multiple, independently developed software environments, the multiple software environments can each integrate with the system by utilizing source software using scalable error management. For example, source software or executables (e.g., applications) using scalable error management can be distributed to all suppliers of internal cores to the vehicular control system, and the suppliers can integrate the source software/applications into their respective internal cores. Accordingly, scalable error management uses portable software to enable a structure-based exchange of data between one or more error manager satellites and an error manager aggregator.

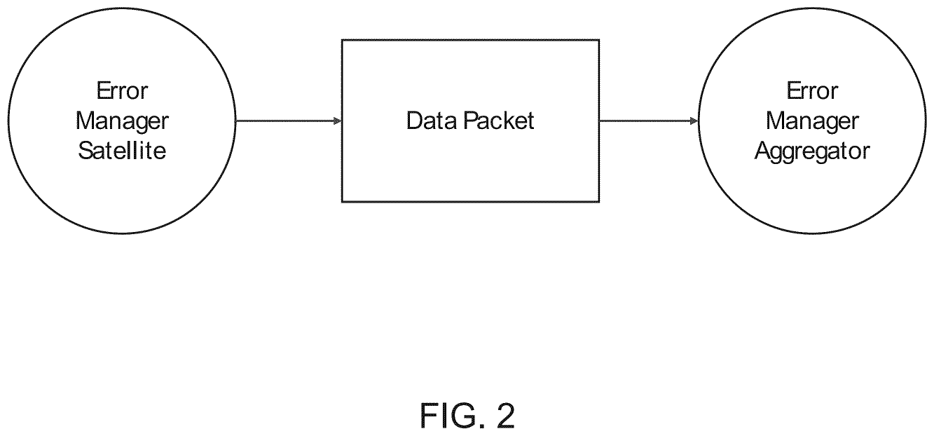

As illustrated in FIG. 2, the error manager satellite periodically communicates a packet of data to the error manager aggregator. In packaging the packet of data, the error manager satellite uses a running counter and checksum to ensure integrity of the packet. To reduce the size of the data packet, the error manager satellite may package an array of error bits. In these examples, the packet contains only errors applicable to the error manager satellite, resulting in a packet that contains the smallest amount of data possible. The packet may also include debugging information. Errors of the same automotive safety integration level (ASIL) may be included in the same packets, and errors of different ASIL may be packaged into separate packets. By organizing the packets by the ASIL of the errors contained in the packets, scalable error management promotes freedom from interference (FFI).

By generating the code and the structure for communication on both the primary (i.e., aggregator) and secondary (i.e., satellite) side of error management, the error managers may generate packets with optimal, configurable debugging information. Moreover, the generated code can be deployed on heterogeneous central processing units (CPUs), even where each CPU operates on a different operating system. Similarly, the generated code can be deployed on ECUs containing different hardware that are used throughout the equipped vehicle.

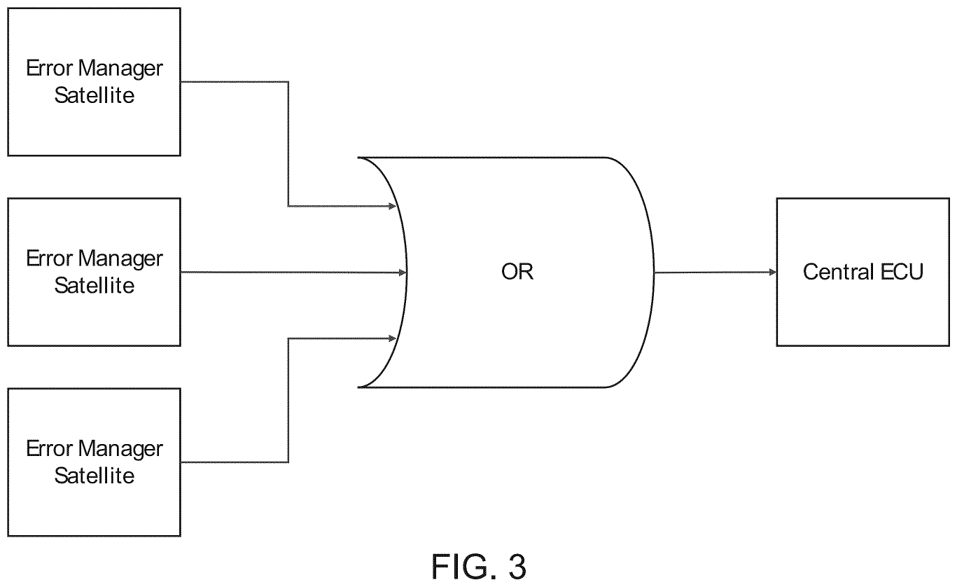

As illustrated in FIG. 3, the vehicular control system may include multiple error manager satellites that communicate errors to one primary ECU (e.g., central ECU or master ECU). The error manager satellites may communicate the errors to the primary ECU simultaneously, causing a high volume of data to arrive at the primary ECU. To process the high volume of data, the primary ECU may use a general function inhibit determination (FID) that accounts for an error from any of the error manager satellites. For example, if any of the error manager satellites sends an error to the primary ECU, the primary ECU may raise a general FID regardless of which error manager satellite sent the error. That is, the primary ECU may raise a single FID in response to an error the primary ECU receives from any of the error manager satellites. This increases the operating speed of the primary ECU in comparison to an ECU in a safety architecture that uses conventional error management.

In a safety architecture that uses conventional error management, the safety architecture is designed to have the least possible errors produced during operation. Accordingly, an error manager will check an entire list of potential errors. Upon receiving an error, the error manager will output an FID. The error manager may output multiple potential FIDs, where the number of potential FIDs is approximately half as many as the number of types of errors the error manager may receive. The entire runtime for checking the full list of errors will equal the number of potential errors multiplied by the number of potential FIDs.

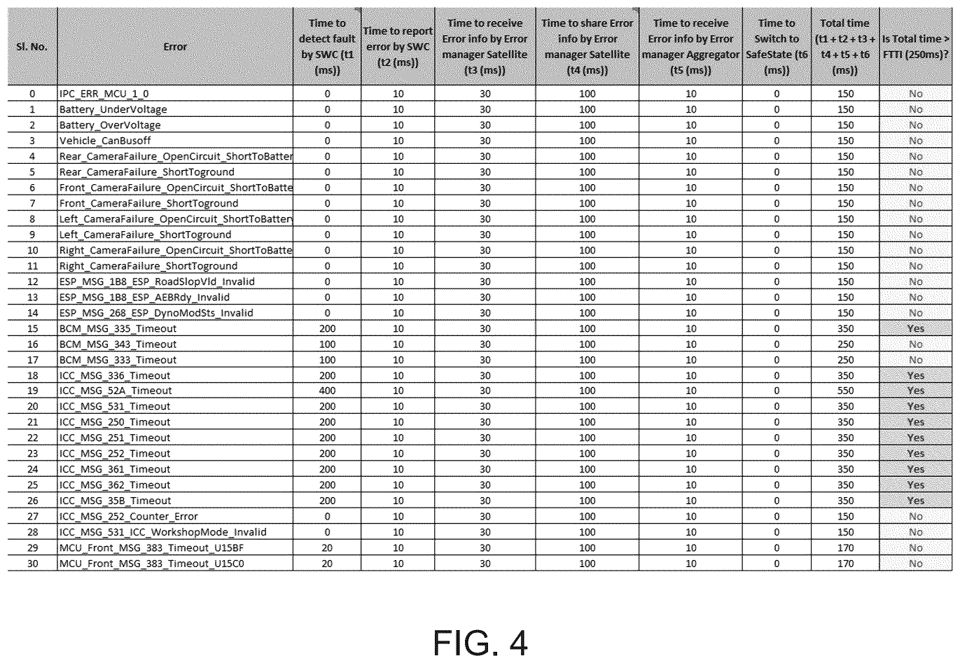

In the safety architecture described herein that implements scalable error management, errors may be packaged into 32-bit integers. Alternatively, the errors may be packaged into 64-bit integers when the safety architecture uses 64-bit CPUs, and the errors may be packaged into 128-bit integers or higher for vector processing units. Optionally, a series of 32-bit integer error dependency masks are predetermined at runtime for every FID. Accordingly, when the error manager periodically receives a packet of data, the error manager will set an FID if any value in the error dependency mask is not zero (i.e., a value in the error dependency mask indicates an error). For example, 1,000 error statuses may be packaged into a 30-byte packet. Accordingly, the runtime for checking the full list of errors in the scalable safety architecture is reduced by a factor of 32 from the runtime for an equivalent safety architecture that uses conventional error management. In some examples, branch instructions may be replaced with bitwise operations (e.g., bitwise ORs) to improve performance. Furthermore, scalable error management allows the error dependency masks and error bit representations to stay in a cache during the entire operation of the error manager. FIG. 4 is a table of data that demonstrates the runtime performance of an example safety architecture that uses scalable error management.

In an example of error communication under the safety architecture, an error may be detected by an SWC. The SWC may report the detected error to an error manager satellite. The error manager satellite may receive the error report and send error information regarding the detected error to an error manager aggregator. Optionally, the error manager satellite may compile the error report among a plurality of error reports received from a plurality of SWCs in communication with the error manager satellite. Similarly, the error manager aggregator may receive the error information simultaneously with a plurality of error information reported from other error manager satellites. The error manager aggregator may determine that the error information from the error manager satellite contains a detected error and communicate or assert an output, such as a safe state, to mitigate failure of the SWC and/or systems affected by the SWC.

The scalable error management is adaptable to various safety architectures and at various levels of abstraction. For example, scalable error management may include a safety architecture implemented via distributed error management and degradation management including multiple heterogeneous cores, SOCs, or ECUs that are connected by a high speed or low speed communication interface. Error management, feature degradation, and enforcement of safety behavior may involve implementations ranging from a single CPU with one or more communication buses, to multi-core, multi-SOC systems having one or more communication buses. Generally, scalable error management includes at least one primary core (i.e., master core) primary core circuitry and at least one secondary core (i.e., slave core) or secondary core circuitry. The primary core, also referred to herein as a master core or an error manager aggregator, is responsible for centralized error processing. The secondary cores, also referred to as slave cores or error manager satellites, are responsible for local error detection and reporting.

The secondary core periodically sends all errors and any associated debugging information to the primary core. The primary core may then process the error and determine a response in accordance with the safety architecture. In an example including multiple secondary cores, the secondary cores periodically send errors, and any debugging information associated with the errors, in a deterministic fashion to the primary core (e.g., a central SOC, central ECU, central CPU, etc.). The primary core can then process the errors and determine appropriate outputs. Accordingly, scalable error management reduces complex diagnostic determinations for secondary cores, or for ECUs other than the central ECU.

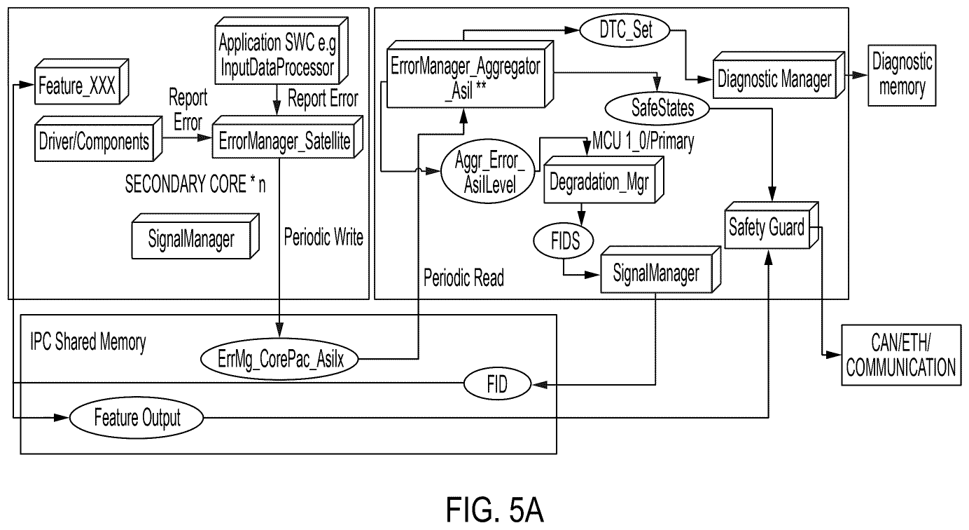

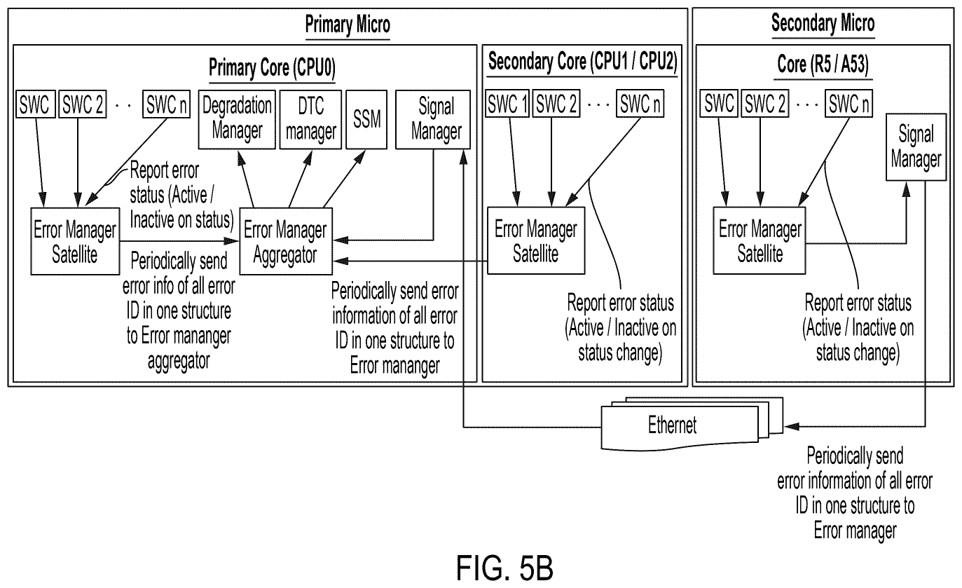

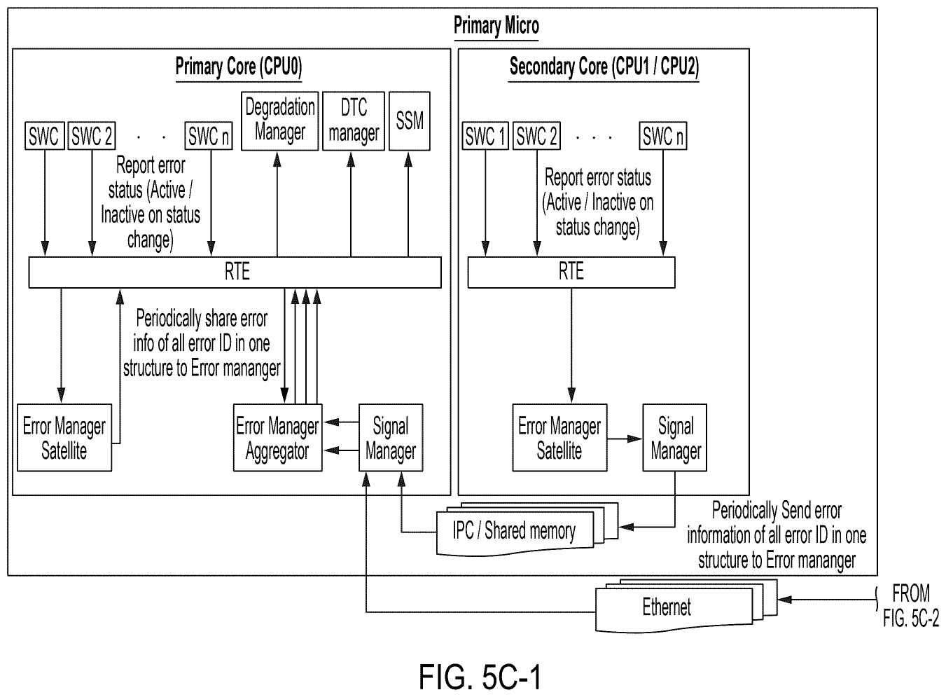

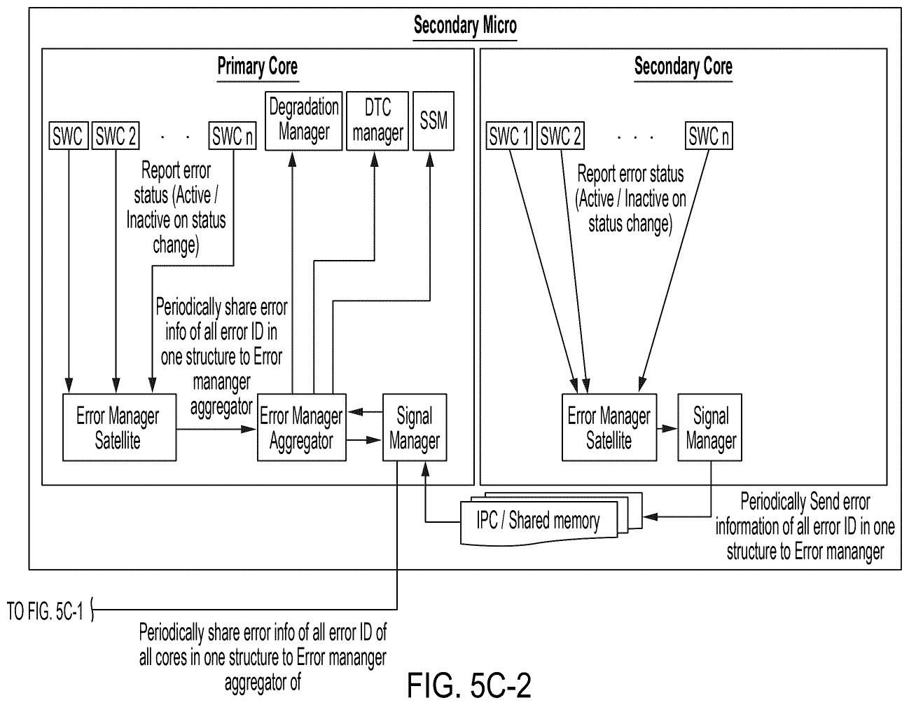

As illustrated in FIGS. 5A-5C, each secondary core may have an error manager satellite that determines a status or error report for one or more of a system, driver, component, SWC, feature, or application, associated with the secondary core. The status may include at least one error. The error manager satellite periodically groups the statuses into a memory-efficient format of data for communication. The error manager satellite encrypts the data, e.g., with end-to-end encryption, and communicates the data to a layer, or medium, of inter-process communication (IPC).

Through the IPC layer, the error manager satellite communicates the data to every primary core of the safety architecture. A primary core may then use the data to determine a function inhibition value, a safe state, and/or a DTC. For example, the primary core may periodically read the data communicated by the error manager satellite to the IPC layer. Each primary core includes a primary error manager. Optionally, a primary core may also include an error manager satellite, for example, when the primary core includes one or more SWCs. The error manager satellite may receive error report statuses from each SWC of the one or more SWCs and report the error status to the error manager aggregator of the primary core. The primary error manager receives the data from the error manager satellite (i.e., from each secondary core) and may determine any combination of the following: a global error state for the system per an ASIL of the system, the safe state to be enforced, and the DTC to be raised.

A degradation manager of each primary core receives primary error manager outputs and determines an FID state (i.e., an FID). The FID state is communicated to the IPC layer, where any core of the safety architecture may access the FID state. For example, a core hosting a function corresponding to the FID state may degrade the function in response to the FID state at the IPC layer. Additionally or alternatively, the primary error manager may produce an output to degrade the function directly.

One or more systems, drivers, components, features, or applications may be associated with the primary error manager. For example, the number of components supported by the primary error manager may depend on the fault tolerant time interval (FTTI) required for the systems associated with the primary error manager. Each core that communicates or asserts safe states on a communication bus of the vehicle will have an instantiation of a safety guard. The communication bus may be a controller area network (CAN) bus, ethernet bus, etc. The safety guard receives safe states communicated or asserted by the error manager and enforces the safe states via the communication bus. For example, the safety guard may receive a safe state asserted by the error manager and enforce a signal equivalent to the safe state on safe CAN signals. Optionally, the primary error manager may determine a DTC. The primary error manager outputs the DTC to a diagnostic manager, and the diagnostic manager may store the DTC in diagnostic memory.

A centralized error definition sheet may define errors and allocate the errors to each core responsible for reporting each error. The centralized error definition sheet may include FID state identifiers that provide a single binary output for disabling a function or system of the vehicle. Optionally, the centralized error definition sheet defines inhibition relationships between the errors and the FID state identifiers or the function inhibition definitions. In some examples, each core may have a definition sheet that is specific to the core. For example, a software script associated with the centralized error definition sheet may generate software code that is specific to each core.

In some examples, a safety architecture may include at least one primary core and at least one secondary core. In other examples, the safety architecture may include a multi-primary core system having one or more communication buses and having safety signals in each primary core. For example, the safety architecture may include a plurality of primary cores and a plurality of secondary cores, wherein each primary core includes a primary error manager, a degradation manager, and a safety guard. Inputs of the primary cores scale to receive communications from the secondary cores and to receive primary error manager communications from the other primary cores, wherein the secondary core communications and primary error manager communications are exchanged through the IPC layer. In further examples, the safety architecture may include a multi-SOC system having one or more communication buses. Optionally, one microcontroller and/or microprocessor may include one or more primary cores, one or more secondary cores, and/or a combination of primary cores and secondary cores. The safety architecture may include one or more microcontrollers and/or microprocessors.

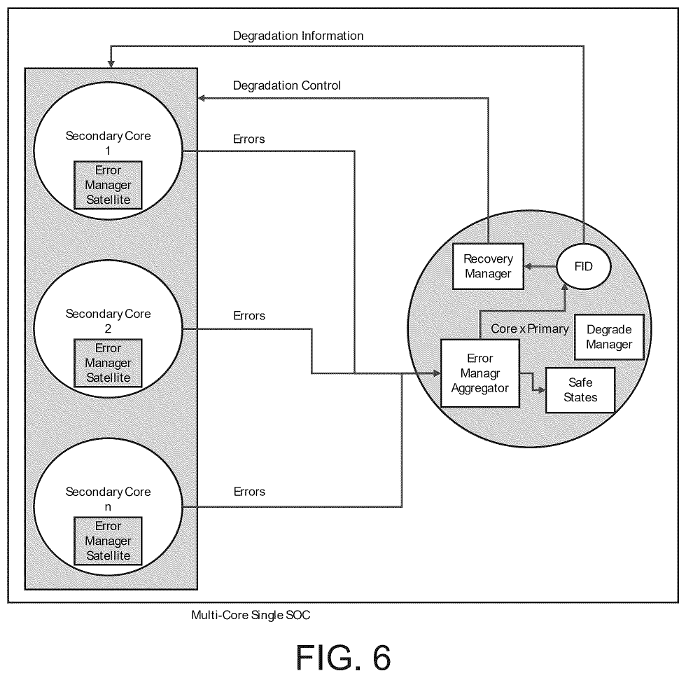

FIG. 6 illustrates a safety architecture that includes a single SOC with multiple cores, such as a small domain controller with a single SOC. Example small domain controllers include a Texas Instruments TDA4, a Nvidia Tegra, and a NXP iMX9.

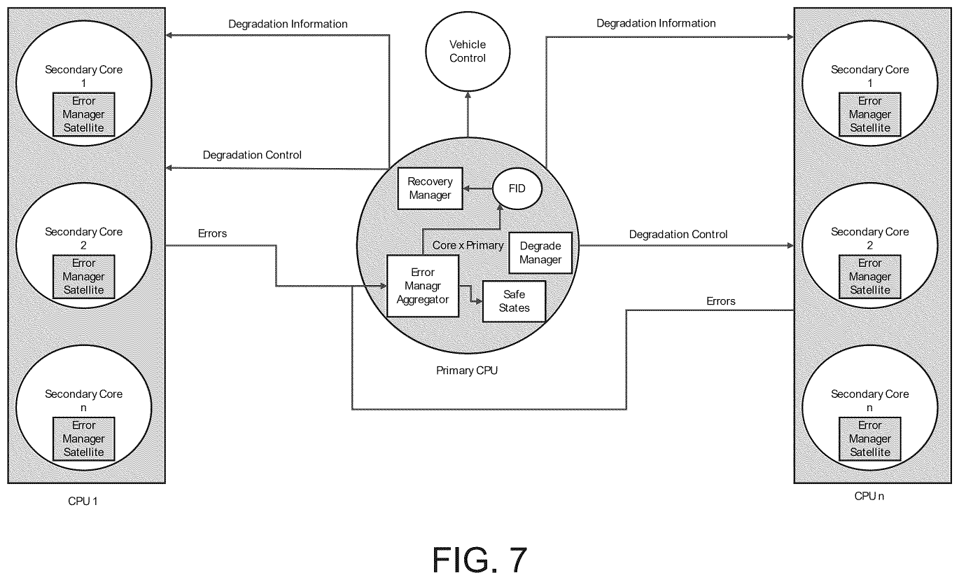

FIG. 7 illustrates a safety architecture using scalable error management that includes multiple SOCs. In the safety architecture, an error manager is deployed across the multiple SOCs (i.e., multiple integrated circuits, multiple computer chips, etc.). For example, multiple powerful SOCs may conduct complex determinations, and a microcontroller operates as a deterministic safety-communicating ECU. One circuit board may include multiple CPUs. Of the multiple CPUs, one CPU is a primary CPU including a primary core, and the remaining CPUs (i.e., secondary CPUs) include one or more secondary cores. The secondary CPUs communicate errors to the primary CPU, and the primary CPU determines a final output to a vehicle equipped with the circuit board. The communication among the CPUs may occur over an internal communication protocol, such as internal ethernet or internal CAN. The safety architecture can operate using scalable error management regardless of the internal communication protocol. Accordingly, scalable error management may apply to safety architectures that include complex high performance computing cores, where the high-performance computing cores include multiple CPUs in a primary/secondary architecture.

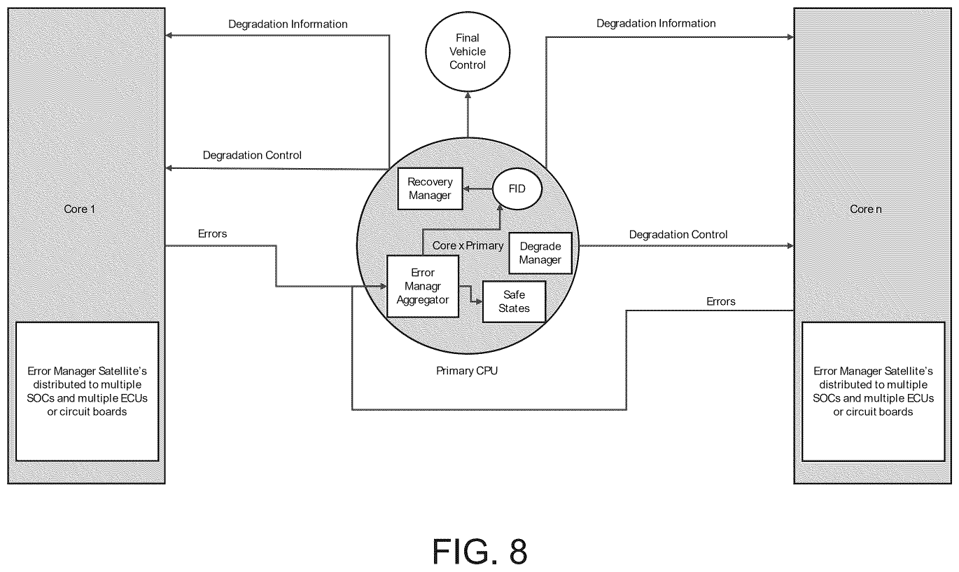

FIG. 8 illustrates a safety architecture using scalable error management implemented at a vehicle level. The vehicular control system may include multiple systems, such as one or more of a front camera system, a radar system, and an ultrasonic system. Each system may be implemented on an ECU and/or a CPU dedicated to that system. In the vehicle-level implementation, a central ECU and/or CPU (e.g., a high performance computer) receives error information from the multiple systems. The central ECU determines the state of the entire safety architecture and determines degradation (i.e., reduction from full operating capacity) of functions of one or more of the systems. For example, a radar ECU may report an error caused by an obstruction. The central ECU may determine to inhibit functions involving fusion of all radar inputs, such as determining to disable blind spot monitoring. More generally, each ECU communicates errors to the central ECU. The central ECU receives the errors and determines a final vehicle-level control. The central ECU may also determine a final vehicle control, an over degradation of a system of the vehicle, and/or determine a centralized decision. In another example, a radar fusion ECU may communicate an error to the central ECU. The central ECU may evaluate the failure of a radar sensor identified by the error and degrade the radar's function by communicating a determination to a radar fusion ECU.

Scalable error management uses the arrangement of primary cores and secondary cores such that a safety architecture can operate across the cores. Accordingly, the cores of the safety architecture do not merely operate in parallel. Scalable error management supports implementation of a safety architecture that includes a plurality of operating system types and/or a plurality of chips (i.e., integrated circuits) or SOCs. Scalable error management supports vehicle-wide degradation. Scalable error management increases the speed of computation and communication among the cores and decreases the bandwidth or volume of data communicated across the safety architecture. Because scalable error management is adaptable to safety architectures at various levels of abstraction, an equipped vehicle may include multiple, embedded layers of scalable error management. For example, a safety architecture of the equipped vehicle may include embedded (i.e., nested) scalable error management at a single SOC, multiple SOCs, a single ECU, multiple ECUs, system level, and/or vehicle level.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red / red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379, 100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular control system, the vehicular control system comprising:
a plurality of sensors disposed at a vehicle equipped with the vehicular control system, wherein individual sensors of the plurality of sensors sense exterior of the equipped vehicle and are operable to capture sensor data;
an electronic control unit (ECU) disposed at the equipped vehicle, the ECU comprising electronic circuitry and associated software;
wherein sensor data captured by the plurality of sensors is transferred to the ECU;
wherein the electronic circuitry of the ECU comprises primary core circuitry and a plurality of secondary core circuitry;
wherein each secondary core circuitry of the plurality of secondary core circuitry is operable to process sensor data captured by at least one sensor of the plurality of sensors and transferred to the ECU;
wherein at least one secondary core circuitry of the plurality of secondary core circuitry, responsive to processing the sensor data captured by the at least one sensor of the plurality of sensors and transferred to the ECU, communicates an error status to an inter-process communication layer (IPC layer); and
wherein the primary core circuitry, responsive to receiving the error status from the at least one secondary core circuitry via the IPC layer, degrades a driving assistance system that uses the sensor data captured by the at least one sensor of the plurality of sensors and transferred to the ECU.

2. The vehicular control system of claim 1, wherein the primary core circuitry, responsive to receiving the error status from the at least one secondary core circuitry, generates a function inhibition determination.

3. The vehicular control system of claim 2, wherein the primary core circuitry communicates the function inhibition determination to the IPC layer, and wherein the at least one secondary core circuitry of the plurality of secondary core circuitry, based on the function inhibition determination, degrades the driving assistance system.

4. The vehicular control system of claim 1, wherein the primary core circuitry, responsive to receiving the error status from the at least one secondary core circuitry, generates a safe state.

5. The vehicular control system of claim 1, wherein the primary core circuitry, responsive to receiving the error status from the at least one secondary core circuitry, generates a diagnostic trouble code.

6. The vehicular control system of claim 1, wherein each secondary core circuitry of the plurality of secondary core circuitry monitors a different system of the equipped vehicle.

7. The vehicular control system of claim 1, wherein individual secondary core circuitry of the plurality of secondary core circuitry communicate respective error statuses in a respective packet of data.

8. The vehicular control system of claim 7, wherein the primary core circuitry degrades the driving assistance system based on the packets of data.

9. The vehicular control system of claim 7, wherein the primary core circuitry applies an error dependency mask to the packets of data, and wherein the primary core circuitry, responsive to applying the error dependency mask to the packets of data, degrades the driving assistance system based at least in part on determining that a value of the error dependency mask indicates an error.

10. The vehicular control system of claim 1, wherein the primary core circuitry is part of a system-on-a-chip (SOC), and wherein each secondary core circuitry of the plurality of secondary core circuitry is part of the SOC.

11. The vehicular control system of claim 1, wherein the primary core circuitry is a part of a first system-on-a-chip (SOC), and wherein each secondary core circuitry of the plurality of secondary circuitry is part of a second SOC different from the first SOC.

12. The vehicular control system of claim 1, wherein the vehicular control system comprises a plurality of primary core circuitry, and wherein each primary core circuitry of the plurality of primary core circuitry is associated with a different plurality of secondary core circuitry.

13. A vehicular control system, the vehicular control system comprising:
a plurality of sensors disposed at a vehicle equipped with the vehicular control system, wherein individual sensors of the plurality of sensors sense exterior of the equipped vehicle and are operable to capture sensor data;
an electronic control unit (ECU) disposed at the equipped vehicle, the ECU comprising electronic circuitry and associated software;
wherein sensor data captured by the plurality of sensors is transferred to the ECU;
wherein the electronic circuitry of the ECU comprises primary core circuitry and a plurality of secondary core circuitry;
wherein each secondary core circuitry of the plurality of secondary core circuitry monitors a different system of the equipped vehicle;
wherein each secondary core circuitry of the plurality of secondary core circuitry is operable to process sensor data captured by at least one sensor of the plurality of sensors and transferred to the ECU;
wherein at least one secondary core circuitry of the plurality of secondary core circuitry, responsive to processing the sensor data captured by the at least one sensor of the plurality of sensors and transferred to the ECU, communicates an error status to an inter-process communication layer (IPC layer);
wherein the primary core circuitry, responsive to receiving the error status from the at least one secondary core circuitry via the IPC layer, generates at least one selected from the group consisting of (i) a function inhibit determination, (ii) a safe state and (iii) a diagnostic trouble code; and
wherein the primary core circuitry, responsive to receiving the error status from the at least one secondary core circuitry via the IPC layer, degrades a driving assistance system that uses the sensor data captured by the at least one sensor of the plurality of sensors and transferred to the ECU.

14. The vehicular control system of claim 13, wherein individual secondary core circuitry of the plurality of secondary core circuitry communicate respective error statuses in a respective packet of data.

15. The vehicular control system of claim 14, wherein the primary core circuitry degrades the driving assistance system based on the packets of data.

16. The vehicular control system of claim 15, wherein the primary core circuitry applies an error dependency mask to the packets of data, and wherein the primary core circuitry, responsive to applying the error dependency mask to the packets of data, degrades the driving assistance system based at least in part on determining that a value of the error dependency mask indicates an error.

17. A vehicular control system, the vehicular control system comprising:
a plurality of sensors disposed at a vehicle equipped with the vehicular control system, wherein individual sensors of the plurality of sensors sense exterior of the equipped vehicle and are operable to capture sensor data;
an electronic control unit (ECU) disposed at the equipped vehicle, the ECU comprising electronic circuitry and associated software;
wherein sensor data captured by the plurality of sensors is transferred to the ECU;
wherein the electronic circuitry of the ECU comprises a plurality of primary core circuitry and a plurality of secondary core circuitry;
wherein each primary core circuitry of the plurality of primary core circuitry is associated with a different plurality of secondary core circuitry;
wherein each secondary core circuitry of the plurality of secondary core circuitry is operable to process sensor data captured by at least one sensor of the plurality of sensors and transferred to the ECU;
wherein at least one secondary core circuitry of the plurality of secondary core circuitry, responsive to processing the sensor data captured by the at least one sensor of the plurality of sensors and transferred to the ECU, communicates an error status in a packet of data to an inter-process communication layer (IPC layer);
wherein a respective primary core circuitry associated with the at least one secondary core circuitry, responsive to receiving the error status from the at least one secondary core circuitry via the IPC layer, applies an error dependency mask to the packet of data; and
wherein the respective primary core circuitry, responsive to applying the error dependency mask to the packet of data, degrades a driving assistance system that uses the sensor data captured by the at least one sensor of the plurality of sensors and transferred to the ECU based at least in part on determining that a value of the error dependency mask indicates an error.

18. The vehicular control system of claim 17, wherein each secondary core circuitry of the plurality of secondary core circuitry monitors a different system of the equipped vehicle.

19. The vehicular control system of claim 17, wherein the vehicular control system comprises a plurality of systems-on-a-chip (SOCs), and wherein each SOC of the plurality of SOCs comprises a primary core circuitry of the plurality of primary core circuitry.

20. The vehicular control system of claim 19, wherein each respective secondary core circuitry of the plurality of secondary core circuitry is part of a different SOC from each primary core circuitry.
